(19) United States
(12) Patent Application Publication
(10) Pub. No.: US 2005/0241111 A1
(43) Pub. Date: Nov. 3, 2005

(54) Ergonomic handle with thumb support

(76) Inventor: David Michael Prokop, Sammamish, WA (US)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(21) Appl. No.: 10/822,286

(22) Filed: Apr. 12, 2004

(51) Int. Cl. E05B 1/00

(52) U.S. Cl. 16/430

(57) ABSTRACT

An improved ergonomic handle for a knife or other hand held implement is disclosed. The ergonomic handle has a laterally projecting thumb support to accommodate a user's thumb while the user grasps the handle. The thumb support maintains the user's thumb in a natural and ergonomic position, laterally offset from the centerline of the handle as the user's hand grasps the handle. The thumb support provides for an efficient, comfortable grip and more control over the knife or other implement during use. It further provides a thumb-force transmitting pressure platform which enables a user to comfortably apply greater pressure to the knife blade or implement than would otherwise be possible without the thumb support.

### FIELD OF THE INVENTION

The present invention relates to ergonomic handles that work in concert with the human hand to provide more effective manipulative operation and other functions such as safety and comfort for the user. More particularly, the present invention relates to ergonomic handles for hand held implements or other devices that are gripped by a user's hand.

### BACKGROUND OF THE INVENTION

Ergonomic handles for hand tools or implements of various designs and configurations are known in the prior art. For example, in knives and like implements, known configurations require the user's thumb to be either wrapped around the handle thus reducing the amount of force that may be applied to the blade or implement, or placed directly on top of the blade, implement or handle in line with the centerline thus reducing the user's overall grip on the handle. Some examples of such devices are disclosed in U.S. Pat. No. 5,365,666; U.S. Pat. No. 4,578,864; U.S. Pat. No. 6,460,356; U.S. Pat. No. Des. 257,686; U.S. Pat. No. 6,502,314, U.S. Pat. No. 6,701,624 and U.S. Pat. No. Des. 363,336.

What the prior art does not disclose is a new ergonomic handle of the present invention which substantially departs from the conventional concepts and designs, and in so doing provides a user with greater comfort and control when grasping the handle.

### SUMMARY OF THE INVENTION

The present invention provides a new ergonomic handle with lateral thumb support that provides a user with greater comfort, safety and control when using a hand tool or device, such as a knife, embodying the invention herein.

In some aspects, the present invention provides an ergonomic handle comprising an elongate member with a proximal end and an opposite distal end and being connectable to a tool or device, and a thumb support member projecting laterally from the elongate member adjacent the proximal end wherein the thumb support member accommodates a user's thumb as the user grasps the handle in one hand. The thumb support member may be positioned such that the user's thumb on the grasping hand rests naturally upon the support member and is laterally offset from the elongate member of the handle. In some aspects of the handle, the thumb support member defines a concave support surface for accommodating the user's thumb. In some embodiments of the handle, the support member defines a generally concave recess having a support surface and peripheral wall portions for accommodating and locating the user's thumb, the peripheral wall portions providing resistance to sliding movement of the thumb relative to the support member. The recess may be dimensioned for a close fit with the thumb.

In some aspects, the present invention provides a knife with an ergonomic handle comprising a blade member having a cutting edge and a handle with a laterally projecting thumb support near the blade end to accommodate a user's thumb while the user grasps the handle. The thumb support maintains the user's thumb in a natural and ergonomic position, laterally offset from the centerline of the handle as the user's hand grasps the handle. The thumb support provides for an efficient grip and more control over the knife during use, and it further provides a thumb-force transmitting pressure platform which enables a user to comfortably apply greater cutting pressure to a knife blade than would otherwise be possible without the provision of the thumb support. The invention further provides a knife handle with a unique thumb-force transmitting platform enabling the application of a comfortable and appreciably “sure-handed” cutting force to the blade.

Accordingly, in some embodiments, the present invention provides a knife comprising a blade member with a cutting edge, and a handle comprising an elongate member with a blade end and an opposite distal end. The handle is connected to the blade member at the blade end. The handle further includes thumb support member projecting laterally from the elongate member adjacent the blade end for accommodating a user's thumb as the user grasps the handle. The thumb support member may be positioned such that the user's thumb on the grasping hand rests naturally upon the support member and is laterally offset from the handle. In some embodiments, the support member defines a support surface for accommodating the user's thumb. The support surface may be generally concave. In further embodiments, the support member defines a generally concave recess with a support surface and peripheral wall portions for accommodating and locating the user's thumb, the peripheral wall portions provide resistance to sliding movement of the thumb relative to the support member. The recess may be dimensioned for a close fit with the thumb of an average adult.

The present invention further provides an ergonomic handle for a knife comprising an elongate member with a blade end and an opposite distal end. The handle is connectable to a knife blade adjacent the blade end. The handle includes a thumb support member projecting laterally from the handle adjacent the blade end for accommodating a user's thumb as the user grasps the handle. The thumb support member may be positioned such that the user's thumb on the grasping hand rests naturally upon the support member and is laterally offset from the handle. In some embodiments, the support member defines a support surface for accommodating the user's thumb. The support surface may be generally concave. In further embodiments, the support member defines a generally concave recess with a support surface and peripheral wall portions for accommodating and locating the user's thumb, the peripheral wall portions provide resistance to sliding movement of the thumb relative to the support member. The recess may be dimensioned for a close fit with the thumb of an average adult.

The present invention further provides a hand implement comprising an operable tool member for performing the particular function of the implement and a handle comprising an elongate member with a proximal end and a distal end. The handle is connected to the tool member at the proximal end. The handle includes a thumb support member projecting laterally from the elongate member adjacent the proximal end for accommodating a user's thumb as the user grasps the handle. The thumb support member may be positioned such that the user's thumb on the grasping hand rests naturally upon the support member and is laterally offset from the handle. In some embodiments, the support member defines a support surface for accommodating the user's thumb. The support surface may be generally concave. In further embodiments, the support member defines a generally concave recess with a support surface and peripheral wall portions for accommodating and locating the user's thumb, the peripheral wall portions provide resistance to sliding movement of the thumb relative to the support member. The recess may be dimensioned for a close fit with the thumb of an average adult.

### BRIEF DESCRIPTION OF THE DRAWINGS

Embodiments of the invention will now be described with reference to the accompanying drawings, in which:

FIG. 1 is a perspective view of a preferred embodiment of the present invention showing a hand tool or implement, in this case a knife, with an ergonomic handle having a thumb support. In this case, the handle is designed for use by a right handed user;

FIG. 2 is a side elevation view of the left side of the ergonomic handle of FIG. 1;

FIG. 3 is a side elevation view of the right side of the ergonomic handle of FIG. 1;

FIG. 4 is a front elevation view of the ergonomic handle of FIG. 1;

FIG. 5 is a rear view of the ergonomic handle of FIG. 1;

FIG. 6 is a top plan view of the ergonomic handle of FIG. 1;

FIG. 7 is a bottom plan view of the ergonomic handle of FIG. 1;

FIG. 8 is a top plan view of the ergonomic handle of FIG. 1 being held in a user's right hand; and

FIG. 9 is a perspective view of the ergonomic handle of FIG. 1 being held in a user's right hand.

### DETAILED DESCRIPTION

The invention disclosed herein may be practiced in embodiments in many different forms. Shown in the drawings and described herein is a preferred embodiment of the ergonomic handle of the present invention in conjunction with a knife. However, it is understood that the present disclosure is an exemplification of the principles of the invention and does not limit the invention to the illustrated embodiment.

For ease of description, a hand tool or implement, in this case a knife, with an ergonomic handle embodying the principles of the present invention is described as shown in the accompanying drawings, where the knife is positioned in its customary cutting or slicing orientation. Terms such as upper, lower, horizontal, vertical, etc., are used herein with reference to this position and orientation.

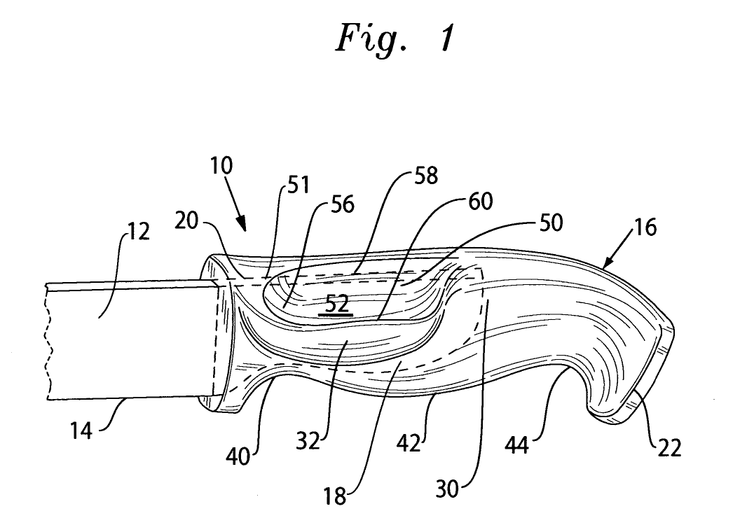

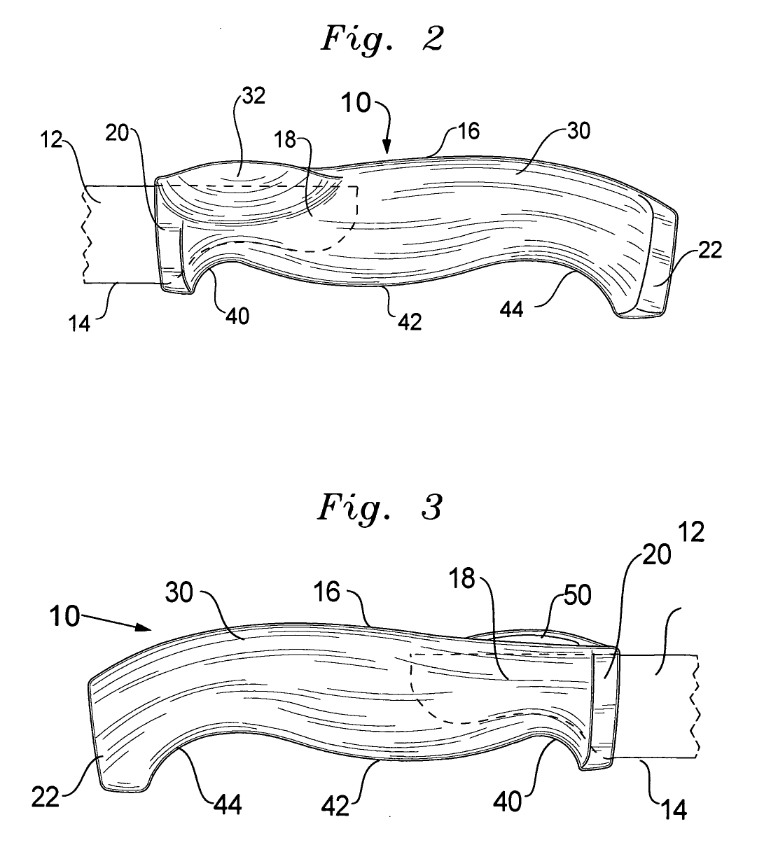

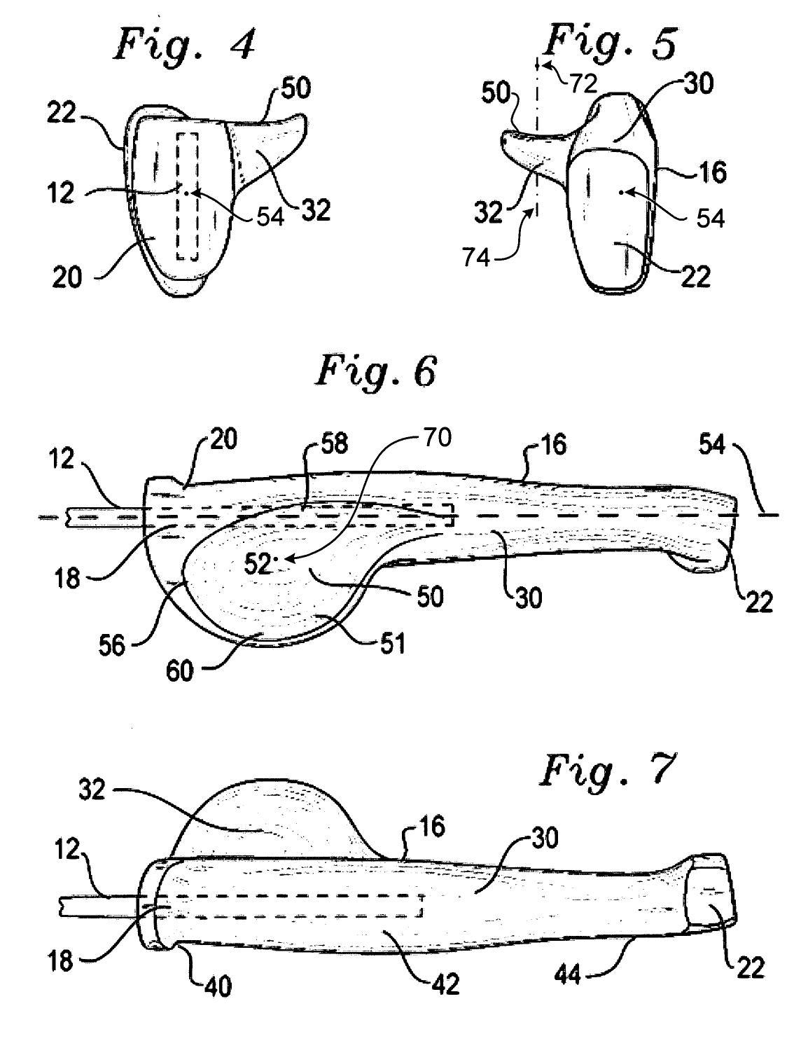

Referring now to the drawings, and more particularly to FIGS. 1-7, there is shown a hand tool or implement, in this case a knife 10 which generally comprises an implement portion or blade member 12, and a handle 16 comprising an elongate member or hand grasping portion 30 having a proximal or blade end 20 connected to the blade member, and an opposite distal end 22.

While the ergonomic handle of the present invention is described and illustrated herein in conjunction with a knife, this should not be taken to limit the invention to such application. The ergonomic handle of the present invention may be used and applied in conjunction with a multitude of tools, devices or applications which require a user to grip the device in at least one hand. For example, the ergonomic handle of the present invention may be applied to devices including (but not limited to) hammers, axes or hatchets, ice axes, handles for hand saws, handles for electric circular saws, bicycle handle grips, fishing rod handles, rowing oars, cutlery, pot and pan handles, cup handles, fireplace pokers, mop handles, vacuum cleaner handles, dough rolling pins, walking canes, walkers, scissors, folding knife handles, wrench handles, pliers, gardening shears, gardening loppers, gardening tools, utility knife handles, hand held staplers, or joy stick or video game controllers.

Referring again to the knife in FIGS. 1-7, the blade 12, which can be of any desired shape or form, is preferably made of stainless steel, or like material, and includes a cutting edge 14 and a shank portion 18 (shown by hatched lines) which extends into the interior of the handle 16, adjacent the blade end 20, to fixedly connect the blade 12 to the handle 16.

The handle 16 further comprises a lateral projection or thumb support member 32 adjacent the blade end 20 of the handle and which projects laterally from the handle. The thumb support member accommodates and supports the thumb of an average adult user as the user grasps the handle 16.

The handle 16 is preferably ergonomically shaped and dimensioned to fit comfortably within the user's gripping hand. Thus, the lower side of the handle 16 includes a first narrow or thin portion 40 near the blade end 20 for accommodating a user's index finger thereby providing a grip stop to reduce slippage of the handle backward in the user's hand, a broad portion 42 approximately midway along the handle's length around which the user's second and third fingers grip, and a second narrow or thin portion 44 near the distal end 22 for accommodating the user's little finger thereby providing a grip stop to reduce slippage of the handle forward in the user's hand. The portions 40, 42 and 44 merge into one another by smooth curves. Similarly, the distal end 22 of the handle 16 is curved downward relative to the rest of the handle.

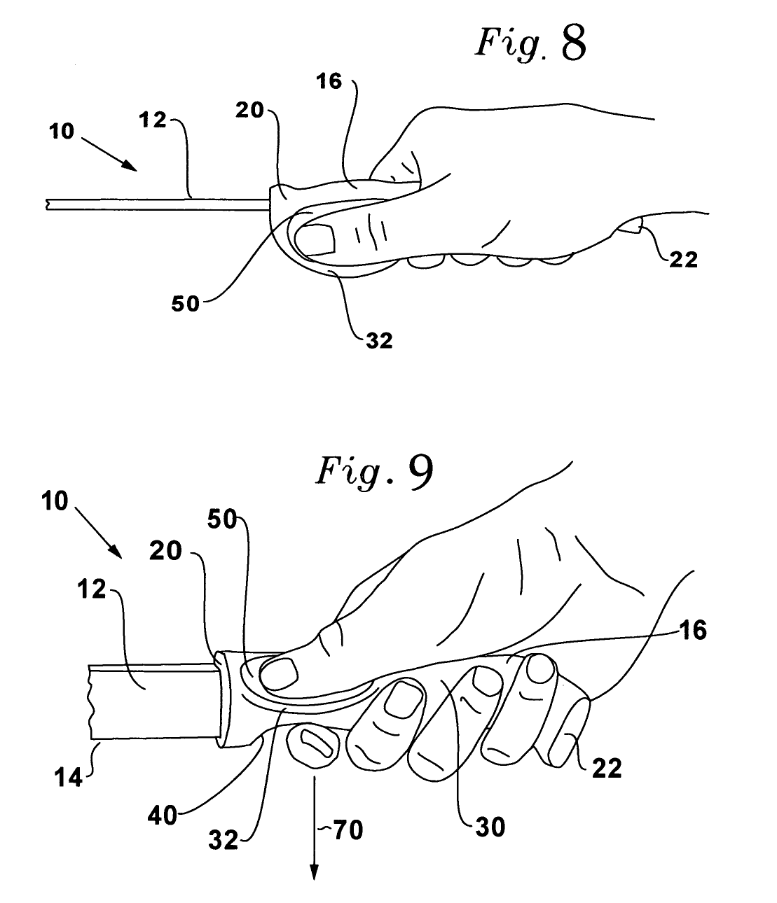

As shown in FIGS. 1 & 6, the thumb support member 32, on its upper surface, defines a generally concave indentation or recess 50 having a support surface 52 and being of a size to accommodate an average adult user's thumb as the user grasps the handle. The recess is offset laterally from the centerline 54 of the handle 16 by an amount sufficient to allow the user's thumb to rest naturally upon the support surface 52 while the user's hand is gripping the handle. The recess 50 is defined by a peripheral wall 51 which can extend completely or substantially around the recess, but preferably the peripheral wall 51 extends around the front and sides of the recess such as wall portions 56, 58 and 60: wall portion 58 is adjacent centerline 54 of the handle 16; wall portion 56 is adjacent the front of the recess; and wall portion 60 is opposite to wall portion 58. Preferably, the peripheral wall 51 is higher at the front than at the back of the recess and tapers down in height from the front of the recess along the sides thereof. Accordingly, as shown in FIGS. 8 and 9, the thumb of a user can be seen to rest naturally upon the thumb support member 32, being accommodated and located therein, and being laterally offset from the elongate member of the handle (FIG. 8). The indentation 50 provides a close fit with an average adult user's thumb for a comfortable fit and increasing the user's overall grip on the handle 16 for a particular level of effort. Furthermore, the thumb support member 32 provides increased control over the knife 10 by enabling the user's thumb to exert a downward axial force 70 to the handle to counteract rotation of the knife about its longitudinal axis while the knife is cutting into hard material. The thumb support member also enables the user to exert a downward force to the blade via the thumb of the grasping hand while maintaining the thumb in a comfortable and ergonomic orientation. The thumb support provides for an efficient grip and more control over the knife during use, and it further provides a thumb-force transmitting pressure platform which enables a user to comfortably apply greater cutting pressure to the knife blade.

The handle 16 may be made of any suitable material, such as wood, rubber, silicon, metal, molded plastic, thermoplastic elastomer, or like material, and may be conventionally secured to the blade. Preferably, the handle is made of hard, molded plastic, which may be injection molded directly around the shank 18 of the blade 12, using known injection molding processes, to affix securing the blade 12 to the handle 16. Alternatively, the handle 16 may comprise of two or more molded plastic parts that may be glued together around shank 18, as is known in the art of knife manufacture, to securely enclose the shank within the handle 16.

The ergonomic handle of the present invention provides a larger handle surface area that reduces pressure points on the grasping hand, resulting in a more comfortable grip and more control over the tool, implement or device having such handle.

The embodiment of the present invention illustrated herein is that of a handle for use in the right hand of a user. It is apparent that a handle for use in the left hand of the user may be readily obtained by translating the drawings herein into their respective mirror images.

1. An ergonomic handle comprising:
a main body portion; and
an appendage support member projecting laterally from the main body portion, the appendage support member comprising a top surface that provides a concave recess wherein a principle axis of the concave recess passing through a center of curvature and a vertex of the concave recess is substantially perpendicular to and offset from a centerline of the main body portion.

2. The handle as claimed in claim 1 wherein the appendage support member accommodates an ergonomic placement of both a distal portion of a first appendage of a hand of a user adjacent the concave recess of the top surface of the appendage support member and a distal portion of a second appendage of the hand of the user adjacent a bottom surface of the appendage support member, wherein upon a grasping of the main body portion by the user, the distal portions of the user's first and second appendages are supported by the appendage support member and are fully offset from a lateral centerline of the main body portion.

3. The handle as claimed in claim 2 wherein the first appendage is a thumb on the hand of the user.

4. The handle as claimed in claim 3 wherein the second appendage is an index finger on the hand of the user.

5. The handle as claimed in claim 3 wherein the concave recess comprises a support surface and peripheral wall portions for accommodating and locating the user's thumb, the peripheral wall portions providing resistance to sliding movement of the thumb relative to the support member.

6. The handle as claimed in claim 5 wherein the concave recess is dimensioned for a close fit with the thumb.

7. The handle as claimed in claim 6 wherein the main body portion comprises a first thin portion near a proximal end of said handle, a second thin portion near a distal end of said handle, and a broad portion between the first and second thin portions, and wherein the broad portion is thicker in cross section than the first and second thin portions, and further wherein the change in the cross sectional thickness between each of the portions is gradual.

8. A knife comprising:
a blade member having a cutting edge; and
a handle comprising:
a main body portion; and
an appendage support member projecting laterally from the main body portion, the appendage support member comprising a top surface that includes a concave recess wherein a principle axis of the concave recess passing through a center of curvature and a vertex of the concave recess is substantially perpendicular to and offset from a centerline of the main body portion.

9. The knife as claimed in claim 8 wherein the appendage support member accommodates an ergonomic placement of both a distal portion of a first appendage of a hand of a user adjacent the concave recess of the top surface of the appendage support member and a distal portion of a second appendage of the hand of the user adjacent a bottom surface of the appendage support member, wherein upon a grasping of the main body portion by the user, the distal portions of the user's first and second appendages are supported by the appendage support member and are fully offset from a lateral centerline of the main body portion.

10. The knife as claimed in claim 9 wherein the first appendage is a thumb on the hand of the user.

11. The knife as claimed in claim 10 wherein the second appendage is an index finger on the hand of the user.

12. The knife as claimed in claim 10 wherein the concave recess comprises a support surface and peripheral wall portions for accommodating and locating the user's thumb, the peripheral wall portions providing resistance to sliding movement of the thumb relative to the support member.

13. The knife as claimed in claim 12 wherein the concave recess is dimensioned for a close fit with the thumb of an average adult.

14. The knife as claimed in claim 13 wherein the main body portion comprises a first thin portion near a proximal end of said handle, a second thin portion near a distal end of said handle, and a broad portion between the first and second thin portions, and wherein the broad portion is thicker in cross section than the first and second thin portions, and further wherein the change in the cross sectional thickness between each of the portions is gradual.

15. A hand implement comprising:
an tool member for performing the particular function of the implement; and
a handle comprising:
a main body portion; and
an appendage support member projecting laterally from the main body portion, the appendage support member comprising a top surface with a concave cavity wherein a principle axis of the concave cavity passing through a center of curvature and a vertex of the concave cavity is substantially perpendicular to and offset from a centerline of the main body portion.

16. The hand implement as claimed in claim 15 wherein the appendage support member accommodates an ergonomic placement of both a distal portion of a first appendage of a hand of a user adjacent the concave cavity of the top surface of the appendage support member and a distal portion of a second appendage of the hand of the user adjacent a bottom surface of the appendage support member, wherein upon a grasping of the main body portion by the user, the distal portions of the user's first and second appendages are supported by the appendage support member and are fully offset from a lateral centerline of the main body portion.

17. The hand implement as claimed in claim 16 wherein the first appendage is a thumb on the hand of the user.

18. The hand implement as claimed in claim 17 wherein the second appendage is an index finger on the hand of the user.

19. The hand implement as claimed in claim 17 wherein the concave cavity comprises a support surface and peripheral wall portions for accommodating and locating the user's thumb, the peripheral wall portions providing resistance to sliding movement of the thumb relative to the support member.

20. The hand implement as claimed in claim 19 wherein the concave cavity is dimensioned for a close fit with the thumb.

21. The hand implement as claimed in claim 20 wherein the main body portion comprises a first thin portion near a proximal end of said handle, a second thin portion near a distal end of said handle, and a broad portion between the first and second thin portions, and wherein the broad portion is thicker in cross section than the first and second thin portions, and further wherein the change in the cross sectional thickness between each of the portions is gradual.
